(19) United States
(12) Patent Application Publication
(10) Pub. No.: US 2015/0369386 A1
(43) Pub. Date: Dec. 24, 2015

(54) MAGNETOCALORIC VALVE

(71) Applicant: GENERAL ELECTRIC COMPANY, Schenectady, NY (US)

(72) Inventors: Matthew Alexander Lehar, Munich (DE); Juan Albeniz Goicoechea, Munich (DE)

(21) Appl. No.: 14/451,869

(22) Filed: Aug. 5, 2014

Related U.S. Application Data
(60) Provisional application No. 62/015,699, filed on Jun. 23, 2014.

(51) Int. Cl. F16K 31/00; F16K 31/06

(52) U.S. Cl. CPC F16K 31/002; F16K 31/06

(57) ABSTRACT

A magnetocaloric valve is described. The valve is largely energetically self-sufficient and contains the following components: (a) a conduit defining a flow channel; (b) a flow channel blocking member; and (c) a driving device configured to move the flow channel blocking member into and out of the flow channel. The driving device has as key components a magnet, an effective amount of a magnetocaloric material, and a counterpoise mechanism. The driving device is powered by alternately cooling and heating the magnetocaloric material using an ambient heat sink and a production fluid heat source. Alternatively, the driving device is powered by alternately cooling and heating the magnetocaloric material using a production fluid heat sink and an ambient heat source. The valve may be kept open or closed by otherwise preventing movement of a movable component of the driving device, for example a shaft, by means of an electrically actuated shaft latch.

### CROSS REFERENCE TO RELATED APPLICATIONS

This application claims the benefit of U.S. Provisional Application No. 62/015,699, entitled “MAGNETOCALORIC VALVE”, filed Jun. 23, 2014, and which is incorporated herein by reference in its entirety.

### BACKGROUND

The present invention relates to magnetocaloric devices which use heat sinks proximate to heat sources to create useful mechanical energy. In particular, the invention relates to devices which are largely energetically self-sufficient.

Many human activities involve the deployment of devices requiring a power source in environments far removed from customary sources of power such as an electricity grid. As such, the development of energetically self-sufficient devices powered by sunlight or the motion of fluids has gained additional currency in recent years, and builds upon a rich tradition of human experience in energetically self-sufficient technologies such as windmills and waterwheels. The accomplishments of the recent past notwithstanding, further enhancements are needed.

The discovery of the magnetocaloric effect nearly a century and a half ago by German physicist Emil Warburg and the sustained interest in materials exhibiting his effect in the intervening years has produced an immense body of knowledge related to magnetocaloric materials and their use as heat sinks in reliance upon the principle of magnetization-demagnetization. The present invention leverages the magnetocaloric effect to produce devices which are largely energetically self-sufficient.

### BRIEF DESCRIPTION

In one embodiment, the present invention provides a magnetocaloric valve comprising: (a) a conduit defining a flow channel; (b) a flow channel blocking member; and (c) a driving device configured to move the flow channel blocking member into and out of the flow channel, the driving device comprising a magnet, an effective amount of a magnetocaloric material, and a counterpoise mechanism; wherein the driving device is configured to be powered by alternately cooling and heating the magnetocaloric material using an ambient heat sink and a production fluid heat source.

In an alternate embodiment, the present invention provides a magnetocaloric valve comprising: (a) a conduit defining a flow channel; (b) a flow channel blocking member; (c) a driving device configured to move the flow channel blocking member into and out of the flow channel, the driving device comprising a magnet, a reservoir configured to accommodate an effective amount of a magnetocaloric material, and a counterpoise mechanism; wherein the driving device is configured to be powered by alternately cooling and heating the reservoir using an ambient heat sink and a production fluid heat source.

In another embodiment, the present invention provides a magnetocaloric valve comprising: (a) a conduit defining a flow channel; (b) a flow channel blocking member; and (c) a driving device configured to move the flow channel blocking member into and out of the flow channel, the driving device comprising a magnet, an effective amount of a magnetocaloric material, and a counterpoise mechanism; wherein the driving device is configured to be powered by alternately cooling and heating the magnetocaloric material using a production fluid heat sink and an ambient heat source.

In yet another embodiment, the present invention provides a magnetocaloric valve comprising: (a) a conduit defining a flow channel; (b) a flow channel blocking member; and (c) a driving device configured to move the flow channel blocking member into and out of the flow channel, the driving device comprising a magnet, a reservoir configured to accommodate an effective amount of a magnetocaloric material, and a counterpoise mechanism; wherein the driving device is configured to be powered by alternately cooling and heating the magnetocaloric material using a production fluid heat sink and an ambient heat source.

In yet another embodiment, the present invention provides a method of producing a fluid, the method comprising: alternately opening and closing a magnetocaloric valve in response to alternately heating and cooling a magnetocaloric component of the valve by thermal contact with a production fluid heat source or heat sink and an ambient heat sink or heat source to regulate the flow of said fluid from a fluid source to a downstream location, the magnetocaloric valve comprising: (a) a conduit defining a flow channel; (b) a flow channel blocking member; and (c) a driving device configured to move the flow channel blocking member into and out of the flow channel, the driving device comprising a magnet, a magnetocaloric material, and a counterpoise mechanism.

### BRIEF DESCRIPTION OF THE DRAWING FIGURES

Various features, aspects, and advantages of the present invention will become better understood when the following detailed description is read with reference to the accompanying drawings in which like characters may represent like parts throughout the drawings. Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for the practice of the invention.

FIG. 1 illustrates a magnetocaloric valve provided by the present invention;

FIG. 2 illustrates a magnetocaloric valve provided by the present invention;

FIG. 3 illustrates a magnetocaloric valve provided by the present invention;

FIG. 4 illustrates a magnetocaloric valve provided by the present invention;

FIG. 5 illustrates a magnetocaloric valve provided by the present invention;

FIG. 6 illustrates a magnetocaloric valve provided by the present invention;

FIG. 7 illustrates a magnetocaloric valve provided by the present invention;

FIG. 8 illustrates a magnetocaloric valve provided by the present invention;

FIG. 9 illustrates a magnetocaloric valve provided by the present invention;

FIG. 10 illustrates a magnetocaloric valve provided by the present invention;

FIG. 11 illustrates a magnetocaloric valve provided by the present invention;

FIG. 12 illustrates a magnetocaloric valve provided by the present invention;

FIG. 13 illustrates a magnetocaloric valve provided by the present invention; and

FIGS. 14A-14D illustrate components of a magnetocaloric valve provided by the present invention.

### DETAILED DESCRIPTION

In the following specification and the claims, which follow, reference will be made to a number of terms, which shall be defined to have the following meanings.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As noted, in one or more embodiments, the present invention provides a magnetocaloric driving device comprising: a magnet, an effective amount of a magnetocaloric material, and a counterpoise mechanism; wherein the driving device is configured to generate mechanical energy by alternately cooling and heating the magnetocaloric material using an ambient heat sink proximate to a heat source. As such, the devices provided by the present invention can be used in almost any application requiring mechanical energy, such as valves, motors, locking mechanisms, generators and the like. This disclosure illustrates the magnetocaloric driving devices provided by the present invention deployed within largely energetically self-sufficient valves.

As noted, in one or more embodiments the present invention provides a magnetocaloric valve and methods for its operation which rely on heat exchange between a magnetocaloric component of the valve and an ambient heat sink and a production fluid heat source, to generate the force required open and close the valve. In alternate embodiments, an ambient heat source and a production fluid heat sink are used to generate the force required open and close the valve.

As is detailed herein, the valve may operate in a variety of states to control a fluid flow, for example the valve may be fully open, partially open, or fully closed. For illustrative purposes, we will first consider only the fully open (“open”) and the fully closed (“closed”) valve states operating in a regime wherein the magnetocaloric material is alternately cooled by thermal contact with an ambient heat sink and warmed by the thermal contact with a production fluid heat source. The discussion which follows illustrates features of one embodiment of a magnetocaloric valve provided by the present invention and its operation, and should not be construed as limiting, since various other embodiments are also disclosed herein.

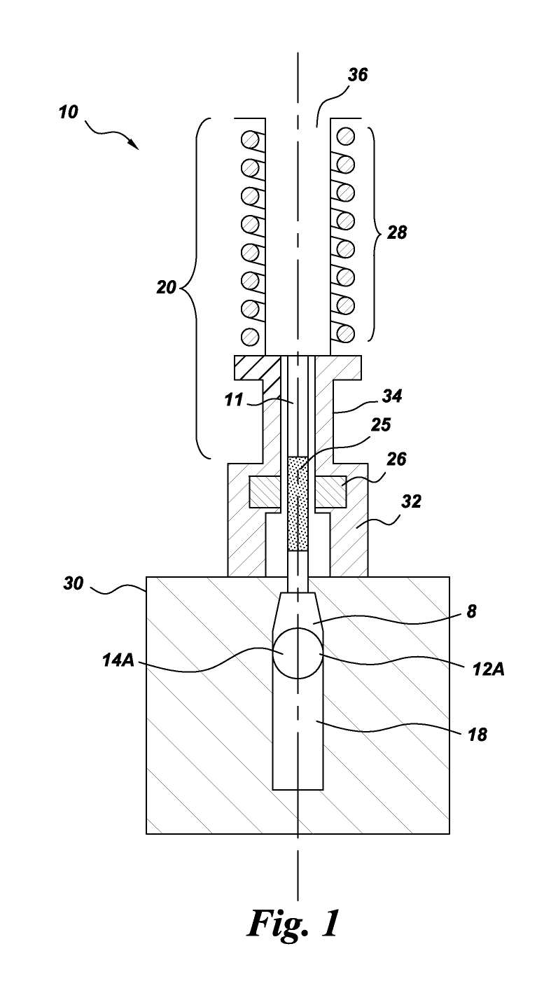

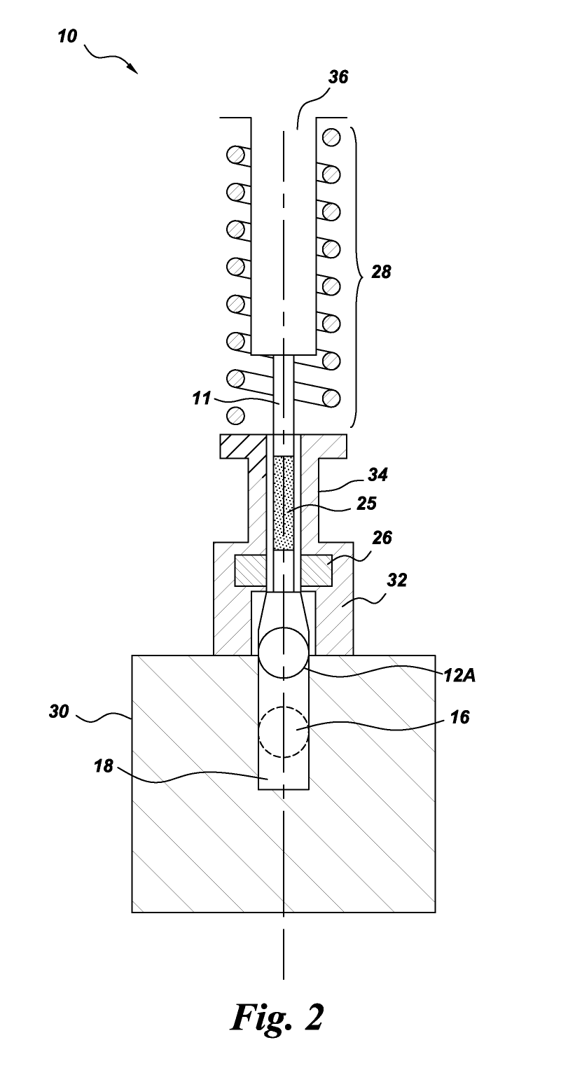

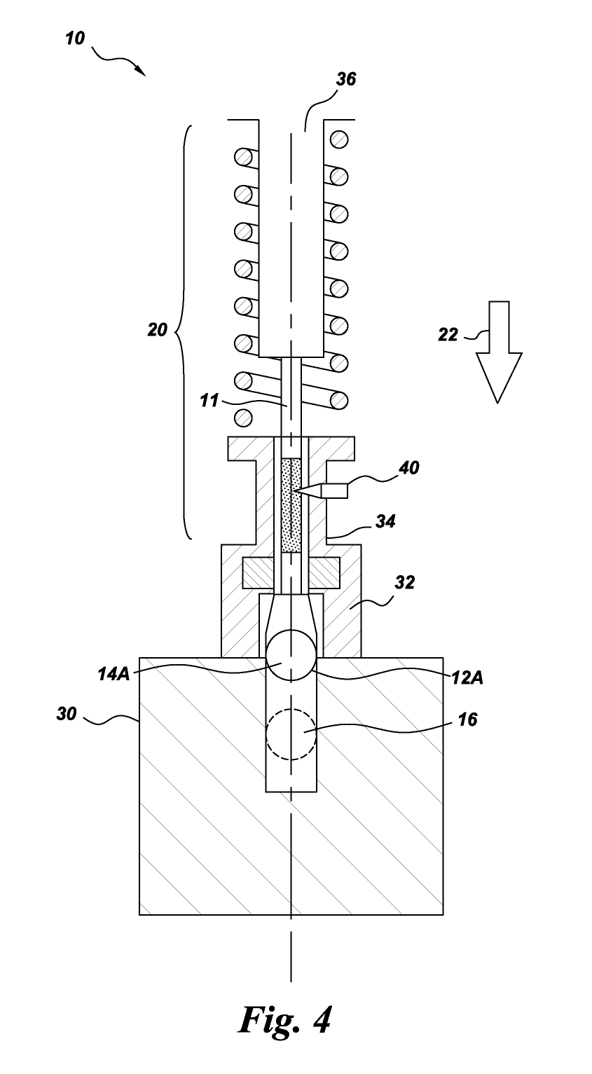

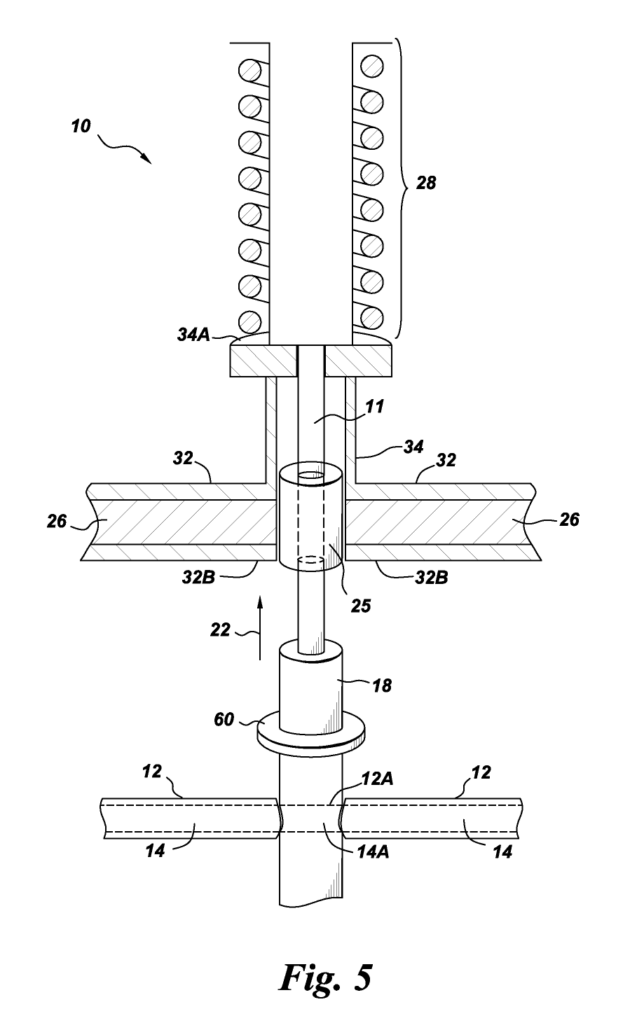

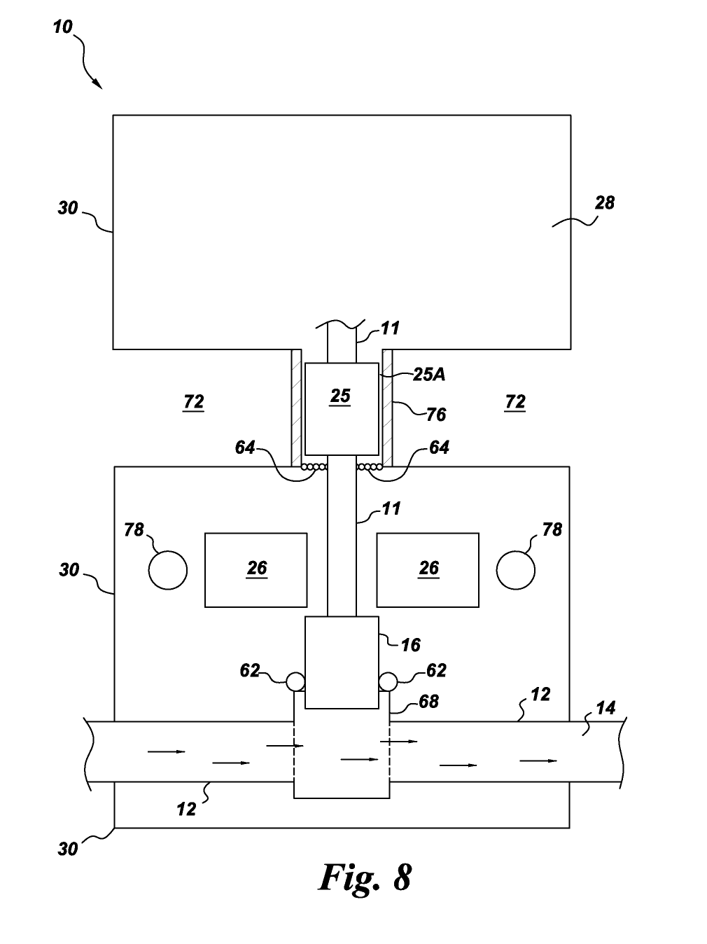

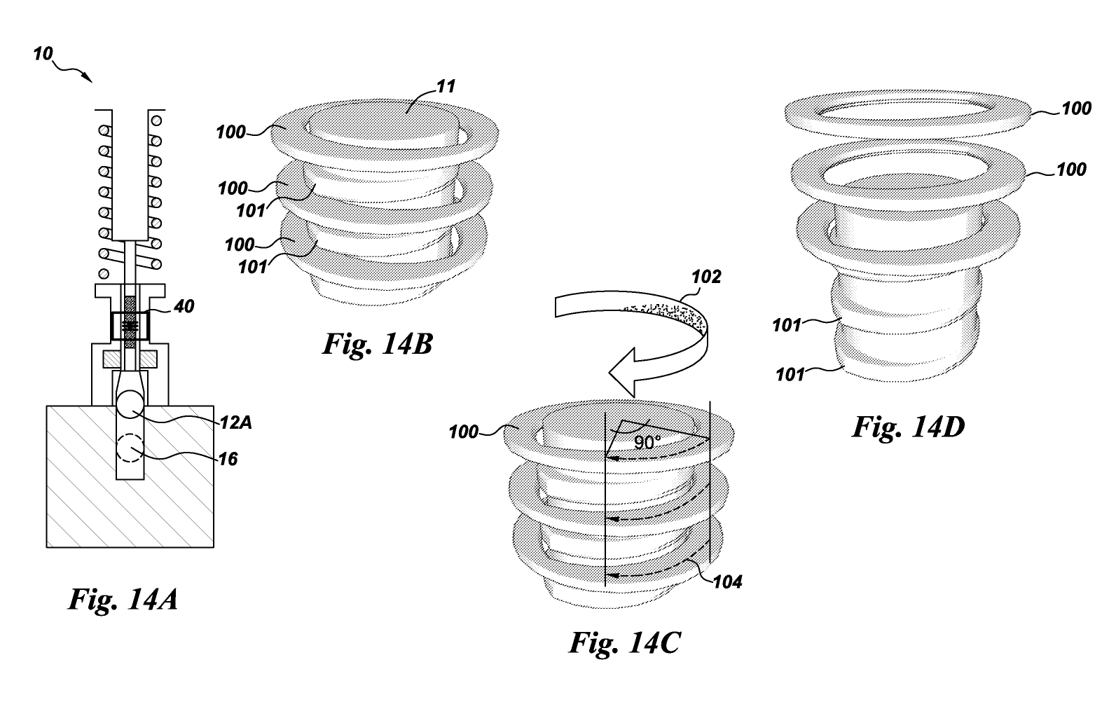

FIGS. 1 and 2 illustrate an embodiment of the present invention in which the magnetocaloric valve 10 is in a fully opened state (FIG. 1) and fully closed state (FIG. 2), and in which embodiment the movement of a perforated valve gate 18 under a magnetic or stored mechanical counter-force opens and closes the valve respectively. Alternate embodiments of the present invention provide for valve closing in response to a magnetic force and valve opening in response to a stored mechanical counter-force. To open the fully closed valve shown in FIG. 2, the shaft-mounted valve gate 18 is allowed to move in response to an attractive interaction between a magnetocaloric material 25 in a magnetically susceptible state and a fixed magnet 26. Magnetically susceptible with respect to the magnetocaloric material means that the magnetocaloric material is attracted to the magnet. Typically this means that the temperature of the magnetocaloric material (T_{MCM}) is below its magnetic transition temperature (T_{C}). As the valve shaft 11, valve gate 18 and magnetocaloric material 25 move in response to the attractive interaction between the magnet and the magnetocaloric material, energy is stored in a counterpoise mechanism 28 coupled to the valve shaft. In one or more embodiments, the counterpoise mechanism is a return spring which stores energy as it is compressed. The counterpoise mechanism tends to counteract the valve shaft motion induced by the attractive interaction between the magnetocaloric material and the magnet. The magnetocaloric component, the magnet and the counterpoise mechanism are sized appropriately such that a force sufficient to overcome the resistance of the counterpoise mechanism is provided by attractive interaction of the magnet with the magnetocaloric material and thereby create a mechanical counter-force in the counterpoise mechanism. As will be appreciated by those of ordinary skill in the art, the magnetocaloric material is attracted to the magnet when cold (T_{MCM} below T_{C}), and is not attracted to the magnet when warm (T_{MCM} above T_{C}). In the embodiment shown, in the closed state the valve is configured so that the magnetocaloric material resides within a cold zone of the valve where the temperature is sufficiently low such that the magnetocaloric material is magnetically active, the cold zone of the valve being in thermal contact with a cold ambient environment. In this state, the magnetic force tending to draw the shaft-mounted magnetocaloric material closer to the fixed magnet is greater than the mechanical counter-force generated in the counterpoise mechanism as the magnetocaloric material is displaced towards the fixed magnet. As the shaft moves, a perforation in the gate (See fluid conduit 12A through gate 18) moves into alignment with a first valve flow channel 14 (See FIG. 5) in fluid communication with a fluid source, and a second valve flow channel 14 in fluid communication with a fluid destination downstream of the valve, and thereby opening the valve. The valve may be kept open or closed by otherwise preventing movement of the shaft. For example, the valve may be held in the closed position (FIG. 2) by an electrically actuated shaft latch 40 (FIG. 4) which inhibits or prevents motion of the shaft. Upon a signal from a controller, the shaft latch may be disengaged from the shaft, whereupon the shaft will move and the fluid conduit 12A defining flow channel 14A (See FIG. 5) through gate 18 will align with the valve flow channels 14 thereby opening the valve. Once in the open position, the shaft latch may re-engage with the valve shaft 11 to prevent the counterpoise mechanism from closing the valve as the magnetocaloric material warms and the strength of the attractive interaction between the magnet and the magnetocaloric material weakens. The magnetocaloric material is warmed by its proximity to a hot production fluid passing through the valve. The extent to which the valve is open may be adjusted by varying the amount of force required for the valve shaft to move while in contact with the shaft latch under the influence of the mechanical counter-force stored in the counterpoise mechanism. A wide variety of mechanisms may be used to secure the valve shaft in a desired location, including more sophisticated mechanical locks such as the twist-lock arrangement illustrated in FIGS. 14A-14D and discussed in detail herein. In one or more embodiments, the valve latch takes the form of an electrical heating element configured to warm the magnetocaloric material above its T_{C} and thereby reduce or eliminate the attraction between a magnetically engaged magnet and cold magnetocaloric material. For example, the production fluid circulation coils 78 shown in FIG. 8 may be replaced by an electric heater coil to achieve such a configuration.

In various embodiments, all of the components of the valve are enclosed within a valve housing 30 which includes portions of the valve housing variously identified herein as magnet housing 32 and shaft housing 34. Typically, the counterpoise mechanism 28 and counterpoise mechanism support member 36 will be fully enclosed with valve housing 30, as shown for example in FIG. 8 herein.

In one or more embodiments, the magnetocaloric valve provided by the present invention is configured for use in oil production operations on the sea floor where the ambient environment consists of deep ocean water which is characterized by its high salinity, 3 to 4 percent by weight, and its cold temperature, 0 to 3 degrees centigrade. Under such circumstances, the ambient environment surrounding the valve may act as a suitable heat sink to which heat may be transferred from the magnetocaloric component of the valve. The production fluid being produced by the oil production operation is typically a hot, multiphase fluid made up of liquid and gaseous hydrocarbons, water and other components such hydrogen sulfide and carbon dioxide. While the temperature of the production fluid presented to a valve on the ocean floor will be cooler than the bottomhole temperature of the producing well, it will typically be considerably hotter than the ambient temperature at the sea floor and the magnetic transition temperature, T_{C}, of the magnetocaloric material. As such, the production fluid may serve as a suitable heat source. The heat sink and its complementary heat source together with the magnet, magnetocaloric material and counterpoise mechanism may be used to provide the power needed to control the operation of the valve. Remarkably, the valve is energetically self-sufficient with respect to its two major operating functions: opening and closing. This self-sufficiency confers a major advantage on the magnetocaloric valves provided by the present invention over hydraulic valves, which are both slow to operate and require hydraulic fluid-filled umbilicals linking the valve to an energy source configured to transmit a pressure wave through the hydraulic fluid to the valve.

In one or more embodiments, the ambient environment can serve as a heat sink in surface oil production operations in cold environments such as the arctic, and the production fluid may be relied upon as the heat source.

Alternatively, the valve may be driven using a hot ambient environment as a heat source and a cold production fluid as a heat sink, as may be the case in water producing wells in which a stream of cold, potable water is being produced from a deep aquifer situated in a hot environment such as a meridional desert.

The magnetocaloric material employed is such that its magnetic transition temperature is greater than the temperature of the heat sink employed, and such that, when cold, it is attracted to the valve magnet. A wide variety of magnetocaloric materials are currently available, and the discovery of new magnetocaloric materials continues at a rapid pace. Suitable magnetocaloric materials include gadolinium metal; LaFe₁₃₋ₓSiₓ alloys wherein x varies from about 1 to about 2.7, for example LaFe_{11.83}Si_{1.17}, LaFe_{11.7}Si_{1.13}, LaFe_{11.5}Si_{1.15}, and LaFe_{11.2}Si_{1.8}; La_{1-y}Pr_{y}Fe₁₃₋ₓSiₓ alloys wherein y varies from about 0.1 to about 0.5 and x varies from about 1 to about 2, for example La_{0.9}Pr_{0.1}Fe_{12.0}Si_{1.0}, La_{0.8}Pr_{0.2}Fe_{11.8}Si_{1.2}, La_{0.7}Pr_{0.3}Fe_{11.7}Si_{1.3}, La_{0.9}Pr_{0.1}Fe_{11.5}Si_{1.5}, La_{0.8}Pr_{0.2}Fe_{11.5}Si_{1.5}, and La_{0.5}Pr_{0.5}Fe_{11.5}Si_{1.5}; LaFe₁₃₋ₓSiₓH_{β} alloys where x varies from about 1 to about 2.7 and β varies from about 0.1 to about 2, for example LaFe_{12.0}Si_{2.0}H_{0.1}, LaFe_{11.5}Si_{1.5}H_{0.2}, LaFe_{11.7}Si_{1.3}H_{0.3}, LaFe_{11.5}Si_{1.5}H_{0.6}, LaFe_{11.5}Si_{1.5}H_{1.3}, LaFe_{11.5}Si_{1.5}H_{1.5}, and LaFe_{11.5}Si_{1.5}H_{1.8}; La(Fe_{1-y}Mn_{y})₁₃₋ₓSiₓH_{α} alloys where y varies from about 0.01 to about 1, x varies from about 1 to about 2.5, and α indicates the presence of absorbed hydrogen within the lattice of the magnetocaloric material, for example La(Fe_{0.99}Mn_{0.01})_{11.7}Si_{1.3}H_{α}, La(Fe_{0.98}Mn_{0.02})_{11.7}Si_{1.3}H_{α}, La(Fe_{0.97}Mn_{0.03})_{11.7}Si_{1.3}H_{α}, La(Fe_{0.99}Mn_{0.01})_{11.8}Si_{1.2}H_{α}, La(Fe_{0.99}Mn_{0.01})_{11.9}Si_{1.1}H_{α}, La(Fe_{0.99}Mn_{0.01})_{11.4}Si_{1.6}H_{α}, La(Fe_{0.99}Mn_{0.01})_{11.3}Si_{1.7}H_{α}, La(Fe_{0.99}Mn_{0.01})_{11.3}Si_{1.7}H_{α}, La(Fe_{0.99}Mn_{0.01})_{11.1}Si_{1.9}H_{α}, La(Fe_{0.99}Mn_{0.01})_{11.0}Si_{2.0}H_{α}, and La(Fe_{0.99}Mn_{0.01})_{10.8}Si_{2.2}H_{α}; La(Fe_{1-y}Co_{y})₁₃₋ₓSiₓ alloys where y varies from about 0.01 to about 1 and x varies from about 1 to about 2.5, for example La(Fe_{0.96}Co_{0.04})_{11.9}Si_{1.1}, La(Fe_{0.94}Co_{0.06})_{11.9}Si_{1.1}, La(Fe_{0.92}Co_{0.08})_{11.9}Si_{1.1}, La(Fe_{0.91}Co_{0.09})_{11.9}Si_{1.1}, La(Fe_{0.92}Co_{0.08})_{11.8}Si_{1.2}, La(Fe_{0.92}Co_{0.08})_{11.7}Si_{1.3}, La(Fe_{0.92}Co_{0.08})_{11.6}Si_{1.4}, La(Fe_{0.92}Co_{0.08})_{11.5}Si_{1.5}, La(Fe_{0.92}Co_{0.08})_{11.4}Si_{1.6}, La(Fe_{0.92}Co_{0.08})_{11.2}Si_{1.8}, La(Fe_{0.92}Co_{0.08})_{11.1}Si_{1.9}, and La(Fe_{0.92}Co_{0.08})_{11.0}Si_{2.0}; and LaFe₁₃₋ₓ(Co_{y}Si_{z})ₓ alloys where x varies from about 1 to about 2.5, y varies from about 0.1 to about 1.5, z varies from about 1 to about 2 and y+z=x, for example LaFe_{11.2}Co_{0.7}Si_{1.1}, LaFe_{10.7}Co_{0.8}Si_{1.5}, LaFe_{10.98}Co_{0.22}Si_{1.8}, LaFe_{10.8}Co_{0.8}Si_{1.4}, LaFe_{10.9}Co_{0.8}Si_{1.3}, and LaFe_{11.0}Co_{0.8}Si_{1.2}. Other suitable magnetocaloric materials include CrO₂₋ₓFₓ alloys where x varies from about 0.01 to about 0.25, for example CrO_{1.88}F_{0.12}, CrO_{1.89}F_{0.11}, CrO_{1.90}F_{0.10}, CrO_{1.87}F_{0.13}, CrO_{1.86}F_{0.14}, CrO_{1.85}F_{0.15}, CrO_{1.84}F_{0.16}, CrO_{1.83}F_{0.17}, and CrO_{1.82}F_{0.18}.

The magnet employed is typically a permanent magnet but may in certain embodiments be an electromagnet. Suitable permanent magnets are well known in the art and include ceramic magnets, composites comprising iron oxide and barium carbonate and/or strontium carbonate; samarium cobalt magnets, and neodymium-iron-boron magnets. As noted, the magnet and the magnetocaloric component of the valve are sized and positioned such that when the magnetocaloric material is in a cold state the magnet and magnetocaloric material are attracted to one another. In various embodiments, the cold magnetocaloric component is displaced toward the fixed magnet. In various other embodiments, the magnet is displaced toward a cold, fixed magnetocaloric component. In yet other embodiments, both the magnet and cold magnetocaloric component are displaced as a result of the mutual attraction of the cold magnetocaloric material and the magnet.

The strength of the interaction between the magnet and the cold magnetocaloric material will depend on the sizes of the magnet and the magnetocaloric component, their compositions, and their propinquity within the magnetocaloric valve. The strength of the interaction between the magnet and the magnetocaloric material will also determine the force with which the valve can be made to close or open. In various embodiments, the magnet and the amount and nature of the magnetocaloric material may be chosen to coincide with the required force and distance of displacement. In one embodiment, a mass M_{MCM} of a magnetocaloric material having a magnetic moment M_{MCM} and mechanically joined to a movable valve shaft is attracted to a permanent magnet having a field strength H_{PM}. At a given temperature the product M_{MCM}×m_{MCM}×H_{PM} represents the torque developed by the magnetocaloric material and the permanent magnet. Table 1 below further illustrates this concept for a hypothetical magnetocaloric material having a magnetic moment of 100 Joule per Tesla per kilogram. For reference, one Joule is the energy exerted by a force of one Newton acting to move an object through a distance of one meter, and is about the amount of energy required to move a tennis ball upwardly through a distance of one meter. For a substantial amount of magnetocaloric material (See Entry 1) being acted on by a strong magnetic field, a substantial level of torque may be developed and used to perform useful work in a large magnetocaloric valve. Similarly, magnetocaloric valves can be assembled which incorporate smaller amounts of magnetocaloric material and smaller permanent magnets for applications requiring more modest levels of torque to be produced (Entries 2-3).

TABLE 1
Representative Torque Levels Developed Within a Magnetocaloric Valve

| Entry | M_{MCM} | m_{MCM} (kg) | H_{PM} | M_{MCM} × m_{MCM} × H_{PM} |
|---|---|---|---|---|
| 1 | 100 Joule Tesla⁻¹kg⁻¹ | 73 kg | 3 Tesla | 21900 Joule |
| 2 | 100 Joule Tesla⁻¹kg⁻¹ | 10 kg | 1 Tesla | 1000 Joule |
| 3 | 100 Joule Tesla⁻¹kg⁻¹ | 0.1 kg | 0.1 Tesla | 1 Joule |

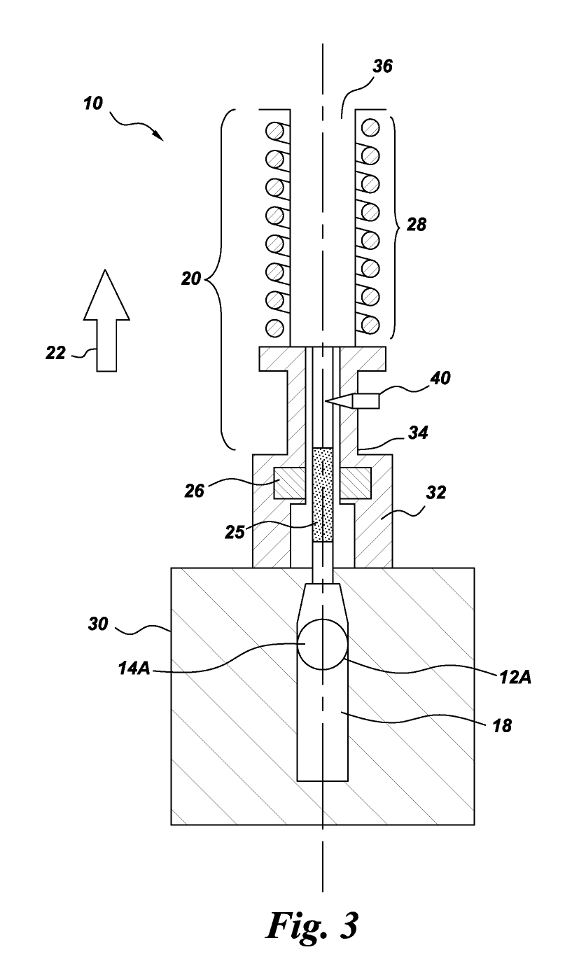

Returning now to the figures, FIG. 3 illustrates a magnetocaloric valve 10 locked in a valve open state by shaft latch 40. In the embodiment shown, a fluid conduit 12A through gate 18 defines a flow channel 14A (FIG. 4). In the valve open state, fluid conduit 12A aligns with complementary valve fluid conduits 12. Valve fluid conduits 12 are themselves fluidly connected via valve gate fluid conduit 12A, shown as a perforation in valve gate 18. The magnetocaloric valve is configured such that in the valve open state, the magnetocaloric material warms due to its proximity to hot production fluid flowing through the valve. Fluid conduit 12A and complementary fluid conduits 12 together form a valve fluid conduit into which flow channel blocking member 16 (FIG. 4) may be moved in order to prevent or control the flow of fluid through the valve. The portions of valve gate 18 which are unperforated are shown as disposed above (upper portion 8, FIG. 1) and below the fluid conduit 12A through gate 18. Either unperforated portion of the valve gate may serve as the flow channel blocking member. For illustrative purposes, the lower portion of the valve gate 18 is shown (FIG. 2) as a flow channel blocking member 16 configured to be moved by driving device 20 into and out of the valve flow channel. Driving device 20 comprises magnet 26, an effective amount of magnetocaloric material 25 and a counterpoise mechanism 28. Counterpoise mechanism 28 is represented as a compressed spring containing sufficient stored energy represented by direction of net force arrow 22 to displace the magnetocaloric material 25, the valve gate 18 and the valve shaft 11 and close the valve.

FIG. 4 shows the valve illustrated in FIG. 3 in its closed state, wherein fluid conduit 12A is no longer aligned with complementary flow channels 12 and flow channel blocking member 16 is considered to have moved into the valve flow channel, the fact that a portion of the valve flow channel 14A has been effectively displaced by the movement of flow channel blocking member 16 notwithstanding. For the purposes of this disclosure, any configuration which enables the driving device to displace a flow channel blocking member to inhibit or prevent flow through the magnetocaloric valve is considered as configured to move the flow channel blocking member into and out of the flow channel.

In the embodiment shown in FIG. 4 shaft latch 40 prevents the valve from reopening as magnetocaloric material 25 cools by thermal contact with a cold ambient across shaft housing 34. Counterpoise mechanism 28 is represented as a decompressed spring containing no stored energy. As the magnetocaloric component cools, the magnetic attraction between the magnet and the magnetocaloric material results in a downward force represented by direction of net force arrow 22, which if unchecked by shaft latch 40 will displace the magnetocaloric material 25, the valve gate 18 and the valve shaft 11 and open the valve.

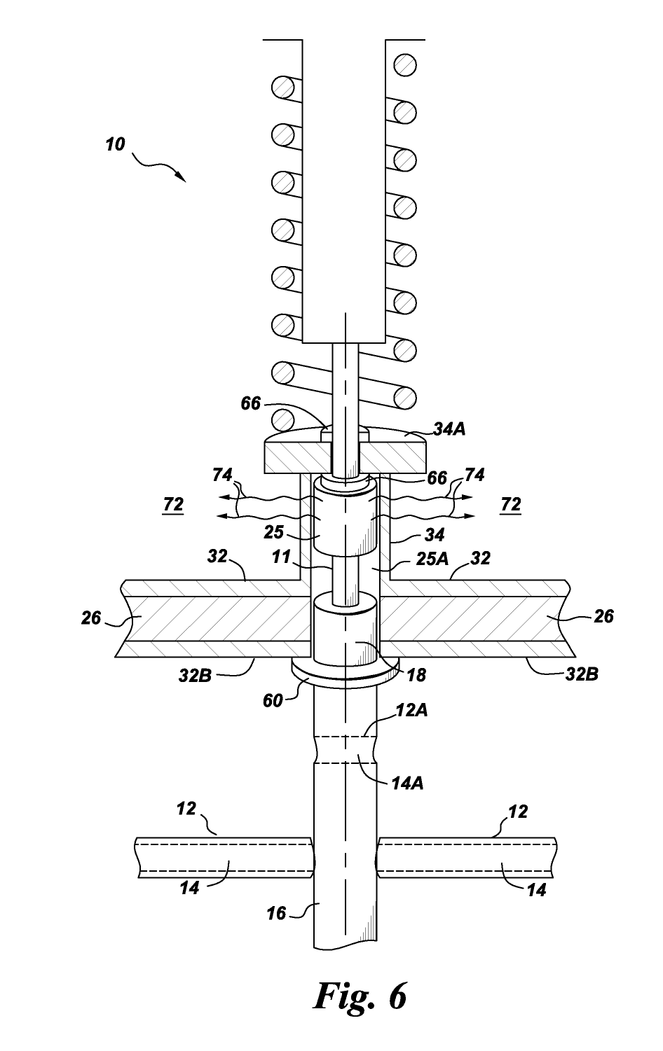

FIG. 5 and FIG. 6 illustrate portions of a magnetocaloric valve 10 in the open (FIG. 5) and closed (FIG. 6) states. In the embodiment shown in FIG. 5, magnetocaloric material 25 is shown as fully magnetically engaged with valve magnet 26 as would be the case when a cold magnetocaloric component is initially drawn into an energetically preferred position relative to the fixed magnet 26. Counterpoise mechanism is represented as a compressed spring containing sufficient stored energy represented by direction of net force arrow 22 to displace the magnetocaloric material 25, the valve gate 18 and the valve shaft 11 and close the valve once the magnetocaloric material 25 warms and its magnetic attraction to magnet 26 weakens. The upper surface 34A of the shaft housing 34 serves a stop against which the spring is compressed. The fluid conduit 12A defining flow channel 14A through valve gate 18 is shown as being aligned with valve conduits 12. Valve gate 18 is equipped with gate seat 60 which is configured to seat against the underside 32B of magnet housing 32 when the magnetocaloric valve is fully closed.

In the embodiment shown in FIG. 6, magnetocaloric material 25 is shown in a warm state and as having been drawn by the compressed spring (FIG. 5) back to an energetically preferred position within a cavity 25A configured to accommodate the magnetocaloric component and defined by the shaft housing 34. Heat flow represented by arrows 74 is shown as proceeding from the warm magnetocaloric material 25 across a heat transmissive wall of shaft housing 34 to a cold ambient environment 72. Counterpoise mechanism 28 is represented as a fully decompressed spring containing no stored energy. Seals 66 prevent fluid communication between the interior of the shaft housing cavity 25A and the counterpoise mechanism 28 and serve to prevent damage to the magnetocaloric component as it is drawn away from magnet 26. The fluid conduit 12A defining flow channel 14A through valve gate 18 is shown as being out of alignment with valve conduits 12 which are terminated at flow channel blocking member 16. Gate seat 60 of valve gate 18 is shown as engaged with the underside 32B of magnet housing 32.

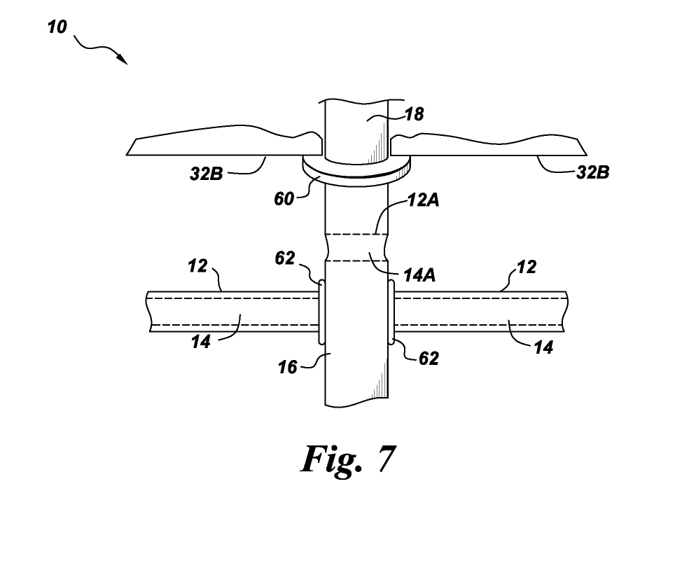

Referring to FIG. 7, the figure represents a portion of the magnetocaloric valve shown in the valve closed state in FIG. 6 and provides additional details on the blocking of flow channels 14 by flow channel blocking member 16. Contact seals 62 assure that the ends of fluid conduits 12 conform to the surface of flow channel blocking member 16 and prevent ingress of production fluid into the interior of valve housing 30 (FIG. 1). Contact seals 62 are fixed to the ends of fluid conduits 12 and are configured to allow the valve gate to move from fully open state, to a partially open state, to a fully closed state. In the fully open state, contact seals 62 conform to the surface of the valve gate adjacent to flow channel 14A.

Referring to FIG. 8, the figure represents a magnetocaloric valve provided by the present invention and illustrating the counterpoise mechanism 28 as being enclosed within valve housing 30. Magnetocaloric valve 10 is shown in a fully open state. In the embodiment shown, the magnetocaloric component containing the magnetocaloric material 25 is shown within a portion of valve housing 30 equipped with heat transmissive walls 76 to allow thermal communication between the cold ambient 72 and magnetocaloric material 25. Flexible seal 64 allows the magnetocaloric component and the shaft to move while inhibiting thermal communication between the lower, warmer portion of the valve housing enclosing the fixed magnet 26 and the fluid conduits 12 and shaft housing cavity 25A. The valve is equipped with a flow channel blocking member 16 attached to valve shaft 11 which is configured to move into and out of flow channel 14 as it passes through conduit coupling box 68. Flow channel blocking member 16 moves into conduit coupling box 68 as the shaft moves in response to the magnetic attraction of the cold magnetocaloric material 25 to the fixed magnet 26. Contact seal 62 allows the flow channel blocking member 16 to move while preventing ingress of production fluid into the interior of the valve. The valve is equipped with production fluid circulation coils 78 which provide for greater thermal contact of the production fluid with the cold magnetocaloric material. This feature permits the valve to be closed more quickly after its being opened, and eliminates or reduces a valve closure lag time resulting from slow warming of the magnetocaloric material energetically engaged with the magnet.

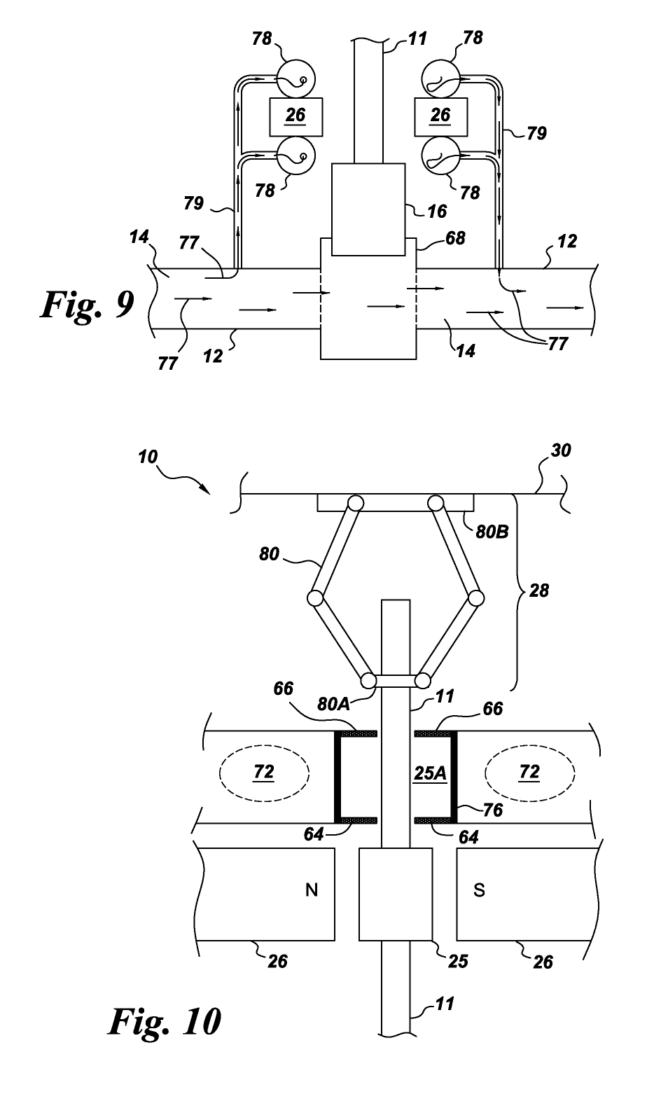

Referring to FIG. 9, the figure represents a more detailed view of the lower portion of a magnetocaloric valve of the type illustrated in FIG. 8. Production fluid circulation coils 78 are configured to provide greater thermal contact between a cold magnetocaloric component (not shown) energetically engaged with fixed magnet 26 and a hot production fluid 77. Circulation coils 78 are in fluid communication with production fluid conduits 12 via slip stream conduit 79. When the valve closes and the magnetocaloric component engages with magnet 26 (as shown in FIG. 5 for example) the flow rate of production fluid 77 through production fluid slip stream conduit 79 increases and allows more rapid warming of the magnetocaloric component and its becoming susceptible to valve closure under the influence of the mechanical counter-force stored in counterpoise mechanism 28. This results in a leakage of a portion of the production fluid 77 past flow channel blocking member 16 in the valve closed state but such leakage can be made to be of short duration by means of one or more on-off valves (not shown) configured to prevent production fluid from bypassing flow channel blocking member 16.

Referring to FIG. 10, the figure represents a portion of a magnetocaloric valve provided by the present invention wherein the counterpoise mechanism 28 comprises flexible elastic arms 80 joined to valve shaft 11 and valve housing 30 via couplings 80A and 80B respectively. The magnetocaloric material 25 is shown as engaged with fixed magnet 26 but subject to displacement toward and into cavity 25A, defined by heat transmissive valve housing walls 76 and seals 64 and 66, in response to energy stored in the counterpoise mechanism upon warming of the magnetocaloric material. Displacement of the magnetocaloric material 25, either in response to its attraction to the fixed magnet 26 when cold, or in response to a mechanical counter-force stored within the counterpoise mechanism 28 when hot, can result in the magnetocaloric valve fully opening, fully closing, partially opening or partially closing, depending on the configuration of the flow channel blocking member and the affected flow channel into which the flow channel blocking member moves into and out of.

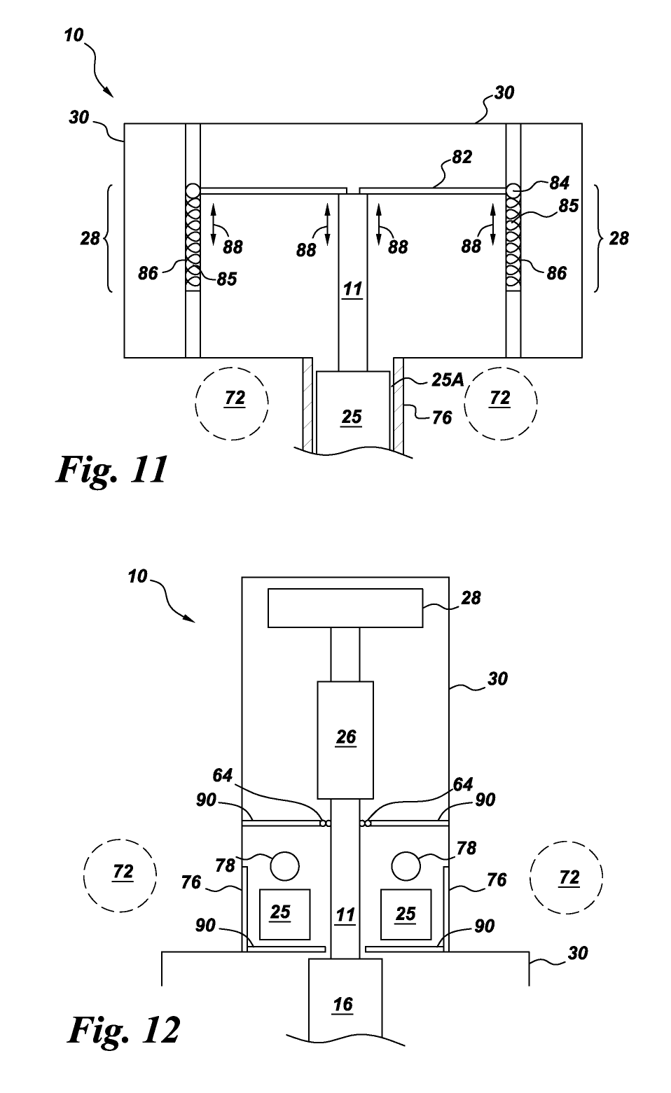

Referring to FIG. 11, the figure represents a portion of a magnetocaloric valve provided by the present invention wherein the counterpoise mechanism 28 comprises cantilever 82 joined to valve shaft 11 and cantilever support member 84. Cantilever support member 84 is joined in turn to a compressible spring 85 disposed within spring housing 86. Spring housing 85 is a partial cylinder defining a slot allowing axial movement of the cantilever as indicated by arrows 88. As the cold magnetocaloric component is drawn toward magnet 26 (not shown) cantilever 82, cantilever support member 84 and valve shaft 11 move downward, thereby compressing compressible spring 85 within spring housing 86 and creating a stored mechanical counter-force which may be used to return the magnetocaloric component to its original position within cavity 25A.

Referring to FIG. 12, the figure represents a portion of a magnetocaloric valve provided by the present invention comprising a fixed magnetocaloric component and a shaft-mounted magnet. In such an embodiment, the magnet is configured to move relative to the magnetocaloric material, the magnetocaloric material being stationary. In response to its attraction to the magnetocaloric material 25 in a cold state, the magnet 26 and valve shaft 11 move through flexible seal 64 and into closer proximity to the cold magnetocaloric material 25. The magnetocaloric valve is configured such that the magnetocaloric material is alternately cooled and heated by thermal contact with cold ambient 72 and hot production fluid respectively. During cooling, no production fluid is allowed to pass through production fluid circulation coils 78 as heat is transferred from magnetocaloric material 25 to the cold ambient across heat transmissive housing walls 76. When a change in valve state is desired, the flow of production fluid through circulation coils is initiated at a flow rate sufficient to rapidly warm the magnetocaloric material and thereby release the magnet which returns across flexible seal 64 under the influence of energy stored within the counterpoise mechanism 28. Thermal barriers 90 inhibit the uncontrolled exchange of heat between the lower and upper portions of the valve and the valve section housing the fixed magnetocaloric component.

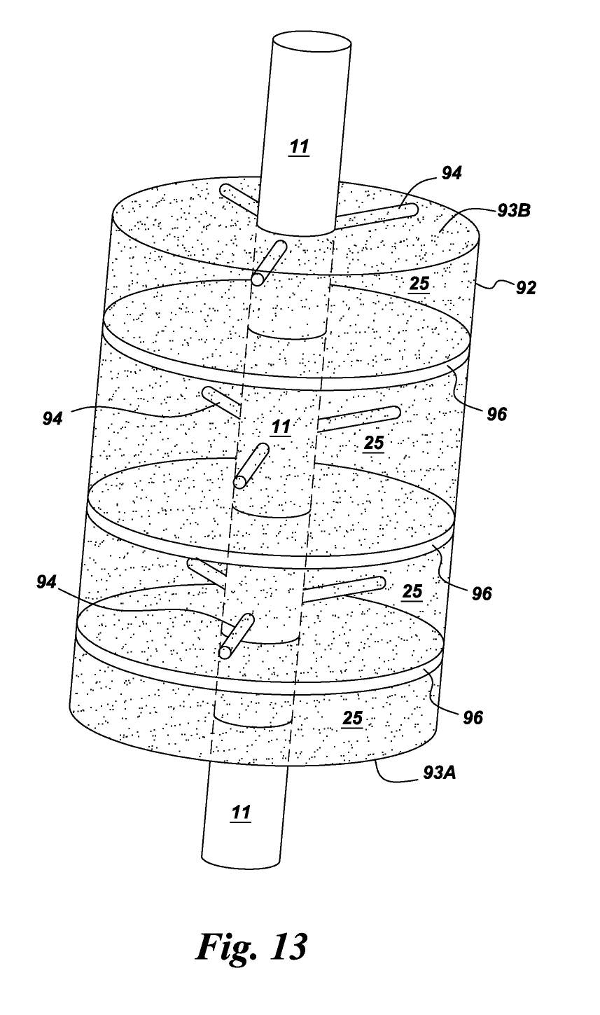

Referring to FIG. 13, the figure represents a shaft-mounted reservoir 92 containing a magnetocaloric material 25 which may be used according to one or more embodiments of the present invention. Reservoir 92 comprises closed ends 93A and 93B, and optionally support struts 94. Heat transmissive fins 96 enhance the rate at which the magnetocaloric material can be cooled and heated.

Referring to FIGS. 14A-D, the figures represent a signal activated shaft latch 40 (twist latch) which may be used to maintain a state of the magnetocaloric valve by preventing motion of, inter alia, the flow channel blocking member. In the embodiment shown in FIG. 14A the magnetocaloric valve is shown in a valve closed state and fixed in that state by shaft latch 40. FIGS. 14B-D illustrate the latching mechanism which includes a set of rotatable locking rings 100 which engage with a set of complementary shaft ribs 101 which are conveniently attached to the shaft by heat shrink fitting a metal sleeve having rib structures 101 on its outer surface to the outer surface of valve shaft 11. Rings 100 and ribs 101 are shaped such that when the rings are in a first rotary position relative to the ribs, the valve shaft 11 may move freely past the rings in response to a force being exerted upon the valve shaft. In a second rotary position relative to the ribs motion of the valve shaft 11 is prevented by contact between the ribs 101 and surfaces of the rings. FIG. 14C illustrates the shaft latch in an unlocked configuration, having been rotated in direction 102 by about 90 degrees from a locked configuration (FIG. 14B), arrow 104 giving both the direction and magnitude of the rotation from the second rotary position to the first rotary position. Various means may be used to drive the rotary motion of the rings. For example, the rings may be driven by a small electric motor. In one or more embodiments, the rings are set in motion or stopped upon a command signal to the device used to rotate the rings.

In one or more embodiments, the magnetocaloric valve provided by the present invention is marinized and configured for operation at great ocean depths. For example, various cavities within the magnetocaloric valve may be fluid filled in order to enhance the valve's resistance to the enormous pressure exerted on it by the water column.

As noted, in one embodiment, the present invention provides a method of producing a fluid using a magnetocaloric valve of the invention. The method may rely energetically on a combination of a hot or cold production fluid with an accessible ambient heat sink or heat source. The method may be practiced in a wide variety of human endeavors such as the production of oil from a deep ocean subsea reservoir. The method is also suitable for use in the chemical industry where hot and cold production fluids in proximity to ambient heat sinks and heat sources are common.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A magnetocaloric valve comprising:
(a) a conduit defining a flow channel;
(b) a flow channel blocking member; and
(c) a driving device configured to move the flow channel blocking member into and out of the flow channel, the driving device comprising a magnet, an effective amount of a magnetocaloric material, and a counterpoise mechanism;
wherein the driving device is configured to be powered by alternately cooling and heating the magnetocaloric material using an ambient heat sink and a production fluid heat source.

2. The magnetocaloric valve according to claim 1, wherein driving device is configured such that the magnetocaloric material is configured to move relative to the magnet, the magnet being stationary.

3. The magnetocaloric valve according to claim 1, wherein driving device is configured such that the magnet is configured to move relative to the magnetocaloric material, the magnetocaloric material being stationary.

4. The magnetocaloric valve according to claim 1, wherein driving device is configured such that both the magnetocaloric material and the magnet are configured to move.

5. The magnetocaloric valve according to claim 1, wherein the counterpoise mechanism comprises a spring.

6. The magnetocaloric valve according to claim 1, wherein the counterpoise mechanism comprises a cantilever.

7. The magnetocaloric valve according to claim 1, wherein the magnetocaloric material is disposed within a reservoir.

8. The magnetocaloric valve according to claim 7, wherein the reservoir containing the magnetocaloric material comprises internal heat transmissive structures (Gets the heat to the innermost MCM quicker)

9. The magnetocaloric valve according to claim 1, further comprising a signal actuated latch configured to fix the relative positions of the magnet and the magnetocaloric material.

10. The magnetocaloric valve according to claim 9, wherein the signal actuated latch is an electrically activated twist lock.

11. A magnetocaloric valve comprising:
(a) a conduit defining a flow channel;
(b) a flow channel blocking member;
(c) a driving device configured to move the flow channel blocking member into and out of the flow channel, the driving device comprising a magnet, a reservoir configured to accommodate an effective amount of a magnetocaloric material, and a counterpoise mechanism;
wherein the driving device is configured to be powered by alternately cooling and heating the magnetocaloric material using an ambient heat sink and a production fluid heat source.

12. A magnetocaloric valve comprising:
(a) a conduit defining a flow channel;
(b) a flow channel blocking member; and
(c) a driving device configured to move the flow channel blocking member into and out of the flow channel, the driving device comprising a magnet, an effective amount of a magnetocaloric material, and a counterpoise mechanism;
wherein the driving device is configured to be powered by alternately cooling and heating the magnetocaloric material using a production fluid heat sink and an ambient heat source.

13. The magnetocaloric valve according to claim 12, wherein driving device is configured such that the magnetocaloric material is configured to move relative to the magnet, the magnet being stationary.

14. The magnetocaloric valve according to claim 12, wherein driving device is configured such that the magnet is configured to move relative to the magnetocaloric material, the magnetocaloric material being stationary.

15. The magnetocaloric valve according to claim 12, wherein driving device is configured such that both the magnetocaloric material and the magnet are configured to move.

16. The magnetocaloric valve according to claim 12, wherein the counterpoise mechanism comprises a spring.

17. The magnetocaloric valve according to claim 12, wherein the counterpoise mechanism comprises a cantilever.

18. The magnetocaloric valve according to claim 12, wherein the magnetocaloric material is disposed within a reservoir.

19. The magnetocaloric valve according to claim 18, wherein the reservoir containing the magnetocaloric material comprises internal heat transmissive structures.

20. The magnetocaloric valve according to claim 12, further comprising a signal actuated latch configured to fix the relative positions of the magnet and the magnetocaloric material.

21. The magnetocaloric valve according to claim 20, wherein the signal actuated latch is an electrically activated twist lock.

22. A magnetocaloric valve comprising:
(a) a conduit defining a flow channel;
(b) a flow channel blocking member;
(c) a driving device configured to move the flow channel blocking member into and out of the flow channel, the driving device comprising a magnet, a reservoir configured to accommodate an effective amount of a magnetocaloric material, and a counterpoise mechanism;
wherein the driving device is configured to be powered by alternately cooling and heating the magnetocaloric material using a production fluid heat sink and an ambient heat source.

23. A method of producing a fluid, the method comprising: alternately opening and closing a magnetocaloric valve in response to alternately heating and cooling a magnetocaloric component of the valve by thermal contact with a production fluid heat source or heat sink and an ambient heat sink or heat source to regulate the flow of said fluid from a fluid source to a downstream location, the magnetocaloric valve comprising: (a) a conduit defining a flow channel; (b) a flow channel blocking member; and (c) a driving device configured to move the flow channel blocking member into and out of the flow channel, the driving device comprising a magnet, a magnetocaloric material, and a counterpoise mechanism.

24. The method according to claim 23, wherein the cooling of the magnetocaloric material is effected using an ambient heat sink, and the heating of the magnetocaloric material is effected using a production fluid heat source.

25. The method according to claim 23, wherein the cooling of the magnetocaloric material is effected using a production fluid heat sink, and the heating of the magnetocaloric material is effected using an ambient heat source.
